(19) United States
(12) Patent Application Publication
(10) Pub. No.: US 2015/0113566 A1
(43) Pub. Date: Apr. 23, 2015

(54) METHOD AND APPARATUS FOR INTERACTION VIA TELEVISION SYSTEM

(71) Applicant: MasterCard International Incorporated, Purchase, NY (US)

(72) Inventor: Martin Koderisch, Stoke Poges (GB)

(21) Appl. No.: 14/517,297

(22) Filed: Oct. 17, 2014

(30) Foreign Application Priority Data
Oct. 21, 2013 (GB) 1318591.3

(51) Int. Cl. H04N 21/482; H04N 21/478; H04N 21/435

(52) U.S. Cl. CPC H04N 21/482; H04N 21/435; H04N 21/478
USPC 725/42

(57) ABSTRACT

A method of providing user interaction with third parties through an electronic programme guide for a television receiver is described. Either the television receiver or computing equipment local to the television receiver and in communication with it comprises a system for assembling an electronic programme guide. The system receives scheduling information for populating the electronic programme guide, and also receives offer information associated with the scheduling information. The system then displays as an electronic programme guide the scheduling information together with its associated offer information. A user selection of offer information is received, and a transaction for the offer information is established. Apparatus and software for achieving this result are also described.

### CROSS-REFERENCE TO RELATED APPLICATION

This application is a U.S. National Stage filing under 35 U.S.C. §119, based on and claiming benefit of and priority to GB Patent Application No. 1318591.3 filed Oct. 21, 2013.

### FIELD OF INVENTION

This invention relates generally to method and apparatus for interaction via a television system. More specifically, embodiments of the invention relate to the augmenting of a programme guide for a television system to allow interaction between third parties and users of the television system.

### BACKGROUND OF INVENTION

Conventional television systems are passive devices, which received a broadcast signal and displayed it to a user. Programming information in the form of a programme guide listing programmes currently shown, or to be shown, became available during this stage as an additional broadcast component.

As television systems shifted from analogue to digital technology, a programme guide was typically provided in the form of a digitally displayed menu. Initially this was not an interactive menu (it simply provided a list of menu choices that could be selected by the user) and was generated as an Electronic Programme Guide (EPG) in a broadcaster's television distribution facilities.

As digital television programming by cable and satellite developed, television systems allowed for interaction between a user and a broadcaster (or other third party) rather than just for passive consumption of broadcast content by the user. This allowed the development of a new form of EPG (known as an interactive electronic programme guide, sometimes IPG) generated at the receiving equipment (either at a suitably equipped television itself, or in an additional component such as a set-top box or a media hub). Interactive menus are generated within the local receiving equipment from raw scheduling data sent by individual broadcast stations or by centralized scheduling information providers. Scheduling data may be broadcast, or may be sent over the Internet.

Interactive electronic programme guide information may be enhanced to allow interaction with recording technology and for effective interaction with pay television. A current electronic programme guide will typically use HTML 5 to present content, and it may be deliverable to other devices such as a mobile telecommunications handset (a smartphone) in communication with the receiving equipment.

Interactivity for the user is typically achieved by another suite of services, accessed for example by the red button on a TV remote controller. These may include alternative viewing angles, alternative or additional content, and in some cases viewer determination of programme content. There are also some examples of using suitably developed TV apparatus for purchasing—U.S. Pat. No. 5,905,521 provides one example of such a technology.

As a user is used to interacting with the electronic programme guide, it would be desirable for this familiarity to be used to provide improved interaction possibilities for the user.

### SUMMARY OF INVENTION

In a first aspect, the invention provides a method of providing user interaction with third parties through an electronic programme guide for a television receiver, wherein either the television receiver or computing equipment local to the television receiver and in communication with it comprises a system for assembling an electronic programme guide, the method comprising: receiving scheduling information for populating the electronic programme guide; receiving offer information associated with the scheduling information; displaying as an electronic programme guide the scheduling information together with its associated offer information; receiving a user selection of offer information; and establishing a transaction for the offer information.

This approach provides a much more effective way to provide offers to a user, as the user is not only presented with offers determined to be appropriate to the user, but the offers are presented at a point at which the user is typically prepared to make interactions anyway.

In embodiments, the method may be performed at least partly by a smart TV. Alternatively, the method may be performed at least partly by a set-top box or by a similar intermediary component such as a media hub.

In embodiments, the method is performed at least partly by a computing device in communication with an apparatus controlling the television receiver. This computing device may be one of a smartphone, a laptop computer and a tablet computer—these can generally be considered as portable “companion devices” when used with television apparatus.

When such a companion device is used, the apparatus controlling the television receiver may receive the scheduling information and offer information, and the computing device may display the electronic programming guide, receive the user selection and establish the transaction.

Moreover, this computing device may comprises a payment application, and this payment application may be used to establish the transaction.

The offer information may received from one or more of broadcasters, merchants and payment providers. The offer information may be associated with scheduling information by the offer provider, or all offer information may be associated with scheduling information for the user together.

In a second aspect, the invention provides computing apparatus for providing user interaction with third parties through an electronic programme guide for a television receiver, wherein the computing apparatus comprises a display, user input apparatus, one or more memories and a suitably programmed processor, wherein the computing apparatus is adapted to: receive scheduling information for populating the electronic programme guide; receive offer information associated with the scheduling information; display as an electronic programme guide on the display the scheduling information together with its associated offer information; receive through the user input apparatus a user selection of offer information; and establish a transaction for the offer information.

In a third aspect, the invention provides a computer program for instructing computing apparatus to perform the method set out above.

In a fourth aspect, the invention provides a method of providing offer information for inclusion in an electronic programme guide for television apparatus of a user, the method comprising: receiving or determining scheduling information for populating the electronic programme guide; identifying user history information for the user; determining offer information specific to the user from the user history information; associating the offer information with the scheduling information; and providing the offer information associated with the scheduling information for provision to the user in the electronic programme guide.

The user history information may comprise user transaction information provided by a payment provider for the user. The user history information may also comprise user viewing history information provided by a broadcast services provider for the user. These two forms of user history information may be used together for particularly well targeted offers.

### BRIEF DESCRIPTION OF FIGURES

Embodiments of the invention will now be described, by way of example, with reference to the accompanying Figures, of which:

FIG. 1 shows elements of an interactive television system using an electronic programme guide and suitable for use in embodiments of the invention;

FIG. 2 shows in modular terms the elements of receiving equipment and associated devices according to embodiments of the invention;

FIG. 3 shows the steps in an embodiment of a method according to one aspect of the invention; and

FIG. 4 provides an example of a screen showing an electronic programme guide according to an embodiment of the invention.

### DESCRIPTION OF SPECIFIC EMBODIMENTS

Specific embodiments of the invention will be described below with reference to the Figures.

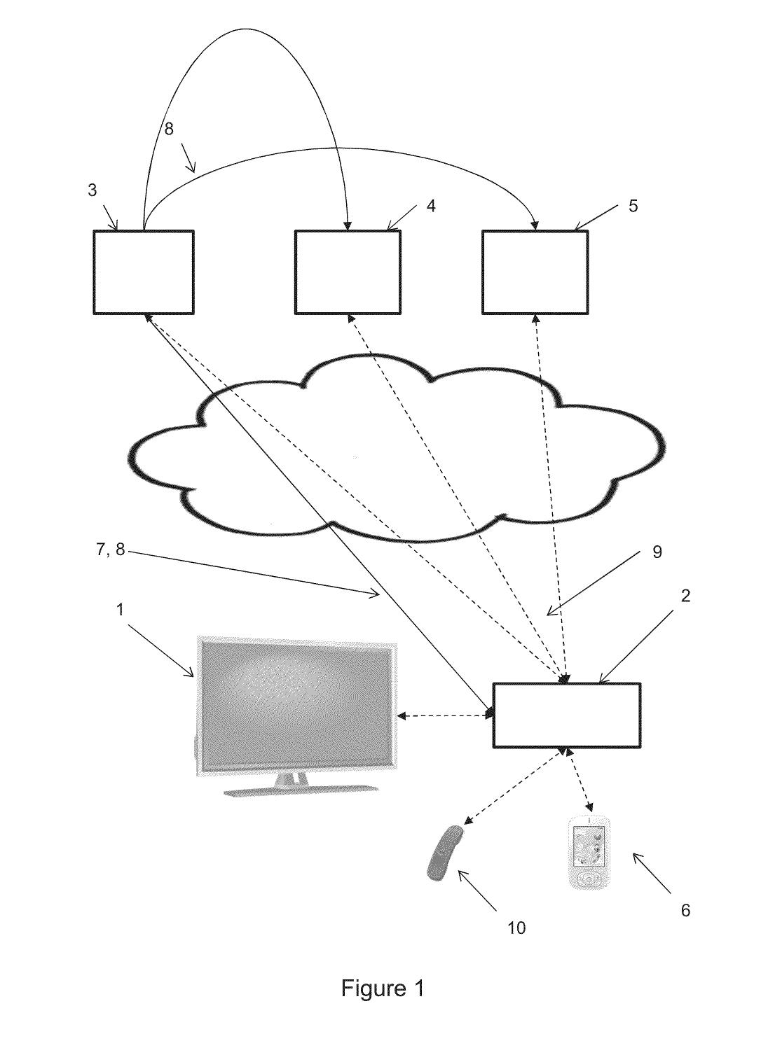

FIG. 1 shows schematically relevant parts of a television system used in aspects of the invention. Broadcaster (or broadcasters) 3 provide both programmes for broadcast 7 and scheduling information 8, shown in this case as provided together over a digital broadcast channel. The programmes 7 and the scheduling information 8 could also be provided through entirely discrete channels, with the scheduling information also potentially provided by a party other than the broadcaster 3. The broadcaster 3 in this case also provides the scheduling information 8 to other parties such as a merchant or merchants 4 and a payment provider 5 associated with the user. This provision of scheduling information 8 is to allow offer information 9 associated with the scheduling information 8 to be prepared. The scheduling information 9 may for example be provided only to merchants 4 from which the user of a television service has indicated that he or she is prepared to receive offers, and the payment provider 5 may be the provider of the or a payment card associated with the user's subscription to a television service provided by the broadcaster 3.

The programmes 7, the scheduling information 8 and the offer information 9 are all shown as received locally to the television 1 by set-top box 2 adapted to receive digital broadcast channels and provide them to the television 1 for display. In alternative arrangements, the set-top box 2 may be integrated within the television 1, or the function of the set-top box may be provided by a media hub (effectively a home server) adapted to provide digital broadcasting to the home and potentially also other functions such as e-mail and even house automation. The set-top box 2 is shown as a smart TV apparatus able to connect to remote servers over the Internet. The set-top box 2 communicates with the television 1 but also communicates (for example, over a local wireless network, or even through the Internet) and remote controller 10 and also with smartphone 6 (which may be for example a mobile telephone handset running an operating system such as Apple iOS or Android). As will be described below, in embodiments electronic programme guide information may be displayed on the television 1 with interaction possible through remote controller 10, but both display and interaction may alternatively involve smartphone 6.

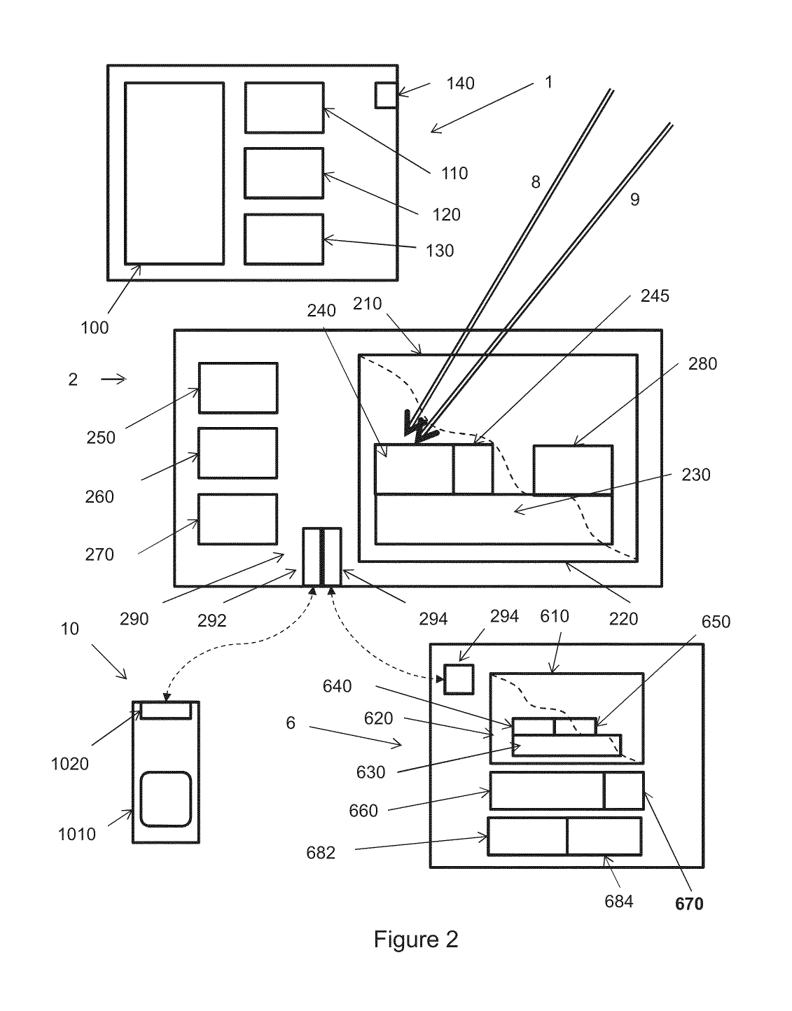

The elements local to the receiving equipment (television 1, set-top box 2, smartphone 6 and remote controller 10) will now be described in more detail in modular and functional terms with reference to FIG. 2.

As described previously, all the components of the television 1 and the set-top box 2 may be provided together in one device such as a smart television—they are shown here as separate devices largely for convenience of display. The television 1 contains a display 100 with an associated display controller 110. The television 1 is shown here as receiving broadcast content through the set-top box 2, but options are also shown for the television 1 to receive content from other sources through ports 140. The television 1 will comprise its own processor 120 and memories 130 containing software to enable operation of the television 1 under the control of the processor 120.

The set-top box 2 comprises the elements necessary to create a digital TV signal from an input bit stream, such as digital TV tuner 250, demultiplexer 260 and decoder 270, along with a central processor unit 210 and memories 220. The operation of a set-top box (or a smart TV) for providing displayed images from broadcast signal is conventional; the person skilled in the art would consult standard reference information on this subject. The central processor unit 210 and memories 220 are here shown as a composite logical space supporting a number of different functions in software. At the lowest software layer is system software 230 including an operating system, device drivers and file management. Over this is an application layer, providing not only applications relating to the production of displayed content from broadcast bitstreams (not discussed further here) and for obtaining and managing paid content 280 but also an electronic programme guide application 240. The electronic programme guide application 240 is typically provided as a standalone application that is populated with scheduling information 8 which may be received through broadcast, but may just as well be provided from an identified data source through the Internet or any other appropriate network. The electronic programme guide application 240 is browser-like in the construction of an image to display, and it will typically use HTML 5 as would a web browser. The electronic programme guide application 240 differs from conventional interactive electronic programme guides in that it also receives offer information 9, and that it also comprises a rules engine 245 to determine the display of the offer information 9 with respect to the scheduling information 8. The set-top box 2 is also shown as having a local networking capability 290, which may comprise more than one technology (for example, it may comprise an infrared controller and port 292 for communication with remote controller 10, and a WiFi controller and antenna 294 for communication with smartphone 6).

The conventional method for a user to interact with the television 1 or (in this case) the set-top box is with remote controller 10. This has a user interface 1010 typically comprising buttons and an infrared transmitter 1020. Two way communication is possible with appropriate types of remote controller 10, but unless a display is provided at the remote controller 10 itself it is generally most effective for the remote controller to be a source of user input to what is displayed on the screen of the television 1.

An alternative approach to use of a remote controller 10 is to use a companion device 6 such as a smartphone (alternatives to a smartphone may be a laptop computer or a tablet computer). This is shown here as having a local networking capability 690 allowing, for example, WiFi communication with the set-top box 2. The companion device here includes its own processor 610 and memories 620, again shown as a logical space in which an application structure is supported. The companion device will have an operating system 630 (such as iOS or Android for a Smartphone, for example, or Windows 7 or Linux for a laptop computer), and this structure will be used to support a number of applications. If the companion device 6 has cellular telecommunications capability, it will also have a SIM 660 and associated hardware, which may include a secure element 670 for containing valuable information such as transaction card credentials. In addition to applications generally found on such a device, this companion device 6 comprises an electronic programme guide application 640 and a payment application 650.

The electronic programme guide application 640 in this case allows electronic programme guide information to be received, already synthesised, from the set-top box 2 and restructured for display on the companion device display user interface 680 comprising in this case display 682 and touchscreen 684. Alternatively, the electronic programme guide application 640 could synthesis scheduling information (and offer information) from the same sources as provide information to the set-top box to allow an electronic programme guide to be generated at the companion device 6 and also displayed there.

The payment application 650 may be an existing mobile payment application or digital wallet such as MasterPass from MasterCard. This allows for transactions associated with a particular payment card to be made online when the user has signed in to an application. In the present case, the electronic programme guide application 640 and the payment application 650 interact so that when an offer presented by the electronic programme guide application 640 is presented to, and selected by, the user, the payment application 650 is used to establish a transaction corresponding to the offer.

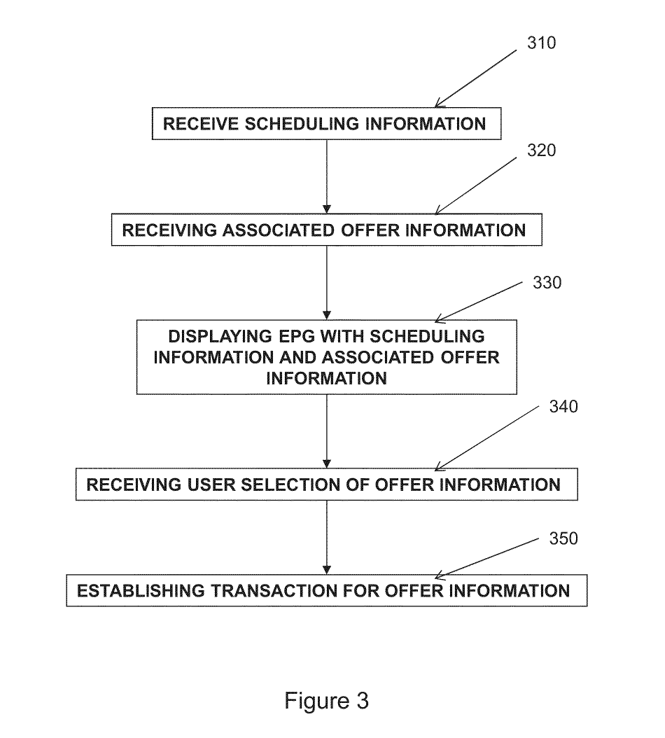

A method in accordance with aspects of the invention of using an electronic programme guide for a television receiver as a medium for making transactions will now be described in general terms with reference to FIG. 3. As shown in FIGS. 1 and 2, either the television receiver itself, or computing equipment local to the television receiver and in direct or indirect communication with it (such as a set-top box or a companion device) comprises a system for assembling an electronic programme guide.

First of all, scheduling information for populating the electronic programme guide is received (step 310). As is described above, this is provided directly or indirectly by the broadcasters. Offer information associated with the scheduling information is also received (step 320). The sources of offer information will be described further below, but possibilities include the broadcaster, other merchants, or a payment card provider. The scheduling information together with its associated offer information is then displayed (step 330) in an electronic programme guide. This display is in a form in which user interaction can be provided—for example by use of a remote controller in response to a display on a television screen, or by a companion device user interface for display on a companion device. A user selection of offer information is received (step 340); and a transaction for the offer information is subsequently established (step 350). These elements are described in more detail below.

Scheduling Information

Scheduling information may be provided for the electronic programme guide in the conventional way, with raw scheduling data either provided over the broadcast in additional information included with the broadcast signal, or provided separately by the individual broadcast stations or by centralized scheduling information providers over another communication path such as the Internet. This enables the electronic programme guide application on the set-top box, smart TV or elsewhere to build an electronic programme guide on the fly around the scheduling information relevant to a given TV receiver.

Offer Information

In embodiments of the present invention, the electronic programme guide is supplemented with offer information relating to purchases that could be made by the user. This offer information is related to the scheduling information—in the arrangement shown, scheduling information is shared by the broadcaster with other providers of offer information to allow each provider to determine which offer information should be associated with which scheduling information. This could however be done in other ways. An intermediary service not associated with the broadcaster or any of the other providers may make organise the associations between offer information and scheduling information, with possible offers simply being provided as a group to the intermediary service. Alternatively, the offers may again simply be provided as a group with the electronic programme guide application itself determining associations between scheduling information and offer information. Privacy considerations may also need to be met to ensure that data personal to the user is not propagated inappropriately.

The determination of what offer information to associate with specific scheduling information will differ according to the provider (or other party taking this determining step), and to the information that they have available. The position for offer information provided by broadcasters, merchants and payment providers is discussed as follows.

If the provider of an offer is a broadcaster, then the broadcaster can use as a main information source the user's previous history in purchasing paid-for television content and services. This may indicate additional broadcast content that could be made the subject of an offer. An offer may be for example to collect points by making purchases through the electronic programme guide system and thereby to obtain exclusive digital content of interest to the user.

If the provider of an offer is a merchant, then the merchant may use the scheduling information to determine programmes which would be a particularly suitable option to use for the merchant to present its goods and services to users. If the user has registered with the merchant and expressed interest in or purchased particular goods or services in the past, the merchant may for example provide offer information only or mainly directed to these goods and services. Merchant offers may also be provided in combination with broadcaster promotions—one possible offer may be a flash offer of free pizza to the first hundred viewers of particular content. Merchant offers may include voucher provision for redemption in a subsequent purchase step.

If the provider of an offer is the payment provider, then the payment provider may use a user transaction card history to identify offers that it would be particularly suitable to provide to the user. Offers could be targeted primarily by time in some cases—for example, if it can be determined from a user's payment history that the user always orders out for food on a Friday night, then offer information relating to takeaway food can be provided for association with scheduling information early on a Friday evening. Offer information may also include loyalty incentives, such as a discount scheme for payment with a specific transaction card.

While ensuring privacy concerns are met, this approach can be used to target offers even more closely to individual users. For example, a user's payment history may be combined with the knowledge that a pay-per-view football match that the user is likely to buy (from previous history) is scheduled to determine that the user is likely to order out for food during the duration of the match and has particular food preferences, in which case specific offers can be customised for the user.

A particularly powerful combination is the use of viewing history (whether pay-per-view history, or simply a history of viewed or captured content) with purchase history (available to the payment provider). This allows different but complementary information about the user's known preferences to be combined. An offer may be chosen to target the programme on a programme guide page that a user is particularly likely to view, and payment history may allow an offer to be targeted to a user's specific interests and allegiances (for example, an offer for takeaway food may be directed to Chinese food rather than pizza, or an offer for a football shirt may be directed to Manchester City rather than Manchester United).

The result of this association process is that specific offer information is associated with specific scheduling information—for example, that the offer information is tagged with a particular programme and so a particular timeslot on a particular channel. This means that the offer information should be displayed appropriately to that timeslot at least (ie not displayed after the timeslot or long before it) and it will generally have the consequence that the offer information is displayed together with the scheduling information.

Display of Offer Information

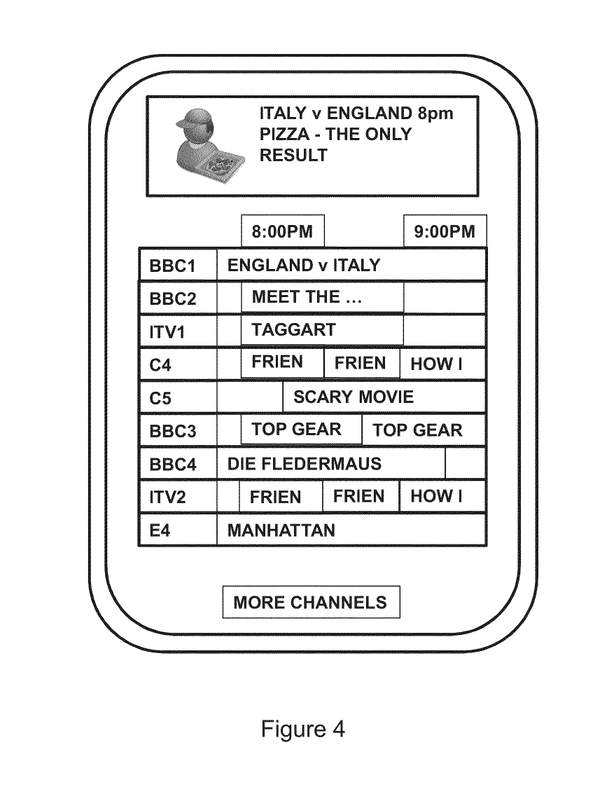

As has previously been discussed, electronic programme guide construction is carried out on the fly for a typical interactive programme guide and a similar approach is available in embodiments of the present invention too. As is normal for interactive programme guides, the application will contain basic templates for electronic programme guide construction and the offer information can be included in the programming guide itself by expansion of this basic template. An example is shown in FIG. 4—this shows scheduling information for main channels shown in the lower part of the screen, with the upper part of the screen provided for display of offer information. In this case the offer information is a merchant offer for pizza delivery directly associated with the football match broadcast on the first channel during the timeslot displayed. Different formats may be used depending on the amount of offer information to display—for example, if there were two offers associated with this selection of channels and timeslots, they might each have a separate area of screen, or they may alternate in occupying the space at the top of the screen. Icons may also be provided in-line with the scheduling information itself.

A variety of display options are possible. In some cases limited electronic programme guide information is provided on the main television screen, in which case an indication of the offer information may also be included. User selection of the offer information could allow a full version of the offer information to be displayed. The electronic programme guide may also in embodiments be displayed on the smartphone or other companion device. In this case it may be appropriate for more intrusive presentation to be made as this will not disrupt programming—for example pop-up alerts for offer information could be produced during the course of the scheduled programme.

User Selection of Offer

The mechanism for user selection of an offer will typically vary with the means used to display the offer. For an offer displayed on the main screen, then the remote controller 10 may be used to navigate the screen to select the offer in the same way that a programme could be selected from the schedule. For an offer displayed on a companion device, the user interface appropriate to the companion device (for example, a touch screen for a smartphone) would be used to select the offer.

When the offer is selected, more offer information (such as a video) may be provided on the television screen or the companion device to allow a user decision to be made, with a user having an opportunity to decline or accept the offer and to customise the transaction (for example, by adding previously provided vouchers). This process of display of further offer information and offer acceptance may be carried out so as not to disrupt programming. This is straightforward if carried out through a companion device, but if the main television screen is used the offer information and any subsequent transaction may be performed through an interactive barker bar above the main programme, or the main programme content may be shrunk to provide a side panel for offer information and transaction while these are active. It would of course also be possible to switch away from the main programming to a separate application related to display and acceptance of offer information for the course of user review and acceptance of offers.

Establish Transaction for Offer

Once the user has accepted the offer, a number of mechanisms are possible for establishing a transaction. Different mechanisms may again be appropriate depending on whether review of the offer is through the television screen, which although likely to be in a private environment may not be well protected against unauthorised purchases (for example, by children) or through a companion device such as a user's smartphone which may be more secure.

If offer display is through a smartphone, the offer display may easily be connected to a payment application held on the smartphone to allow direct payment. This payment application may be a digital wallet such as MasterCard MasterPass, by which a transaction card is securely associated with the smartphone so that purchases on that transaction card can be made with control of the smartphone and knowledge of a signature credential. Even if offer display is through the television, a mechanism may be provided to enable payment from the smartphone—for example, the electronic guide application on the set-top box may prompt the companion device to provide payment when acceptance of an offer has been made on screen.

Other transaction options may defer later stages until a more suitable time. For example, a transaction result may be the downloading of a voucher to the smartphone for later use. In some cases, the transaction may not result in purchase, but only in addition of an offer item to a wish list or gift list. In another case, the transaction may establish approval for a later in-store collection of an item.

As the person skilled in the art will appreciate, modifications and variations to the above embodiments may be provided, and further embodiments may be developed, without departing from the spirit and scope of the invention. Reference to standards and proprietary technologies are provided for the purpose of describing effective implementations, and do not limit the scope of the invention.

1. A method of providing user interaction with third parties through an electronic programme guide for a television receiver, wherein either the television receiver or computing equipment local to the television receiver and in communication with it comprises a system for assembling an electronic programme guide, the method comprising:
receiving scheduling information for populating the electronic programme guide;
receiving offer information associated with the scheduling information;
displaying as an electronic programme guide the scheduling information together with its associated offer information;
receiving a user selection of offer information; and
establishing a transaction for the offer information.

2. The method as claimed in claim 1, wherein the method is performed at least partly by a smart TV.

3. The method as claimed in claim 1, wherein the method is performed at least partly by a set-top box or a media hub.

4. The method as claimed in claim 1, wherein the method is performed at least partly by a computing device in communication with an apparatus controlling the television receiver.

5. The method as claimed in claim 4, wherein the computing device is one of a smartphone, a laptop computer and a tablet computer.

6. The method as claimed in claim 4, wherein the apparatus controlling the television receiver receives scheduling information and offer information, and wherein the computing device displays the electronic programming guide, receives the user selection and establishes the transaction.

7. The method as claimed in claim 4, wherein the computing device comprises a payment application, and wherein the payment application is used to establish the transaction.

8. The method as claimed in claim 1, wherein offer information is received from one or more of broadcasters, merchants and payment providers.

9. The method as claimed in claim 8, wherein offer information is associated with scheduling information by the offer provider.

10. The method as claimed in claim 8, wherein all offer information is associated with scheduling information for the user together.

11. Computing apparatus for providing user interaction with third parties through an electronic programme guide for a television receiver,
wherein the computing apparatus comprises a display, user input apparatus, one or more memories and a suitably programmed processor, and
wherein the computing apparatus is adapted to: receive scheduling information for populating the electronic programme guide; receive offer information associated with the scheduling information; display as an electronic programme guide on the display the scheduling information together with its associated offer information; receive through the user input apparatus a user selection of offer information; and establish a transaction for the offer information.

12. Computing apparatus as claimed in claim 11 and comprising a smart TV.

13. Computing apparatus as claimed in claim 12 and comprising a set-top box or a media hub.

14. Computing apparatus as claimed in claim 11, comprising a computing device in communication with an apparatus controlling the television receiver.

15. Computing apparatus as claimed in claim 14, wherein the computing device is one of a smartphone, a laptop computer and a tablet computer.

16. Computing apparatus as claimed in claim 14, wherein the apparatus controlling the television receiver receives scheduling information and offer information, and wherein the computing device displays the electronic programming guide, receives the user selection and establishes the transaction.

17. Computing apparatus as claimed in claim 14, wherein the computing device comprises a payment application, and wherein the payment application is used to establish the transaction.

18. A method of providing offer information for inclusion in an electronic programme guide for television apparatus of a user, the method comprising:
receiving or determining scheduling information for populating the electronic programme guide;
identifying user history information for the user;
determining offer information specific to the user from the user history information;
associating the offer information with the scheduling information; and
providing the offer information associated with the scheduling information for provision to the user in the electronic programme guide.

19. A method as claimed in claim 18, wherein the user history information comprises user transaction information provided by a payment provider for the user.

20. A method as claimed in claim 18, wherein the user history information comprises user viewing history information provided by a broadcast services provider for the user.
